(19) United States
(12) Patent Application Publication
(10) Pub. No.: US 2007/0126751 A1
(43) Pub. Date: Jun. 7, 2007

(54) Method and device for creating patterns for bead-inlaid plates

(75) Inventor: Bjorn Crona, Norrkoping (SE)

Correspondence Address: POTOMAC PATENT GROUP, PLLC, P. O. BOX 270, FREDERICKSBURG, VA, 22404, US

(73) Assignee: MUNKPLAST AB, Uppsala (SE)

(21) Appl. No.: 10/587,803

(22) PCT Filed: Feb. 3, 2005
(86) PCT No.: PCT/SE05/00146

§ 371 Date: Jul. 31, 2006

(30) Foreign Application Priority Data
Feb. 3, 2004 (SE) 0400219-2

(51) Int. Cl. G09G 5/02

(52) U.S. Cl. 345/589

(57) ABSTRACT

In a method of forming patterns for bead-inlaid plates original pictures such as photographs are used which are converted to digital, bitmapped representations. From such a representation a pattern is then produced by a user selecting an area of the represented picture, by dividing the picture using a grid of intersecting lines forming squares and then a color matching in each square. In an interactive process, the colors in the squares are modified.

### RELATED APPLICATION

This application claims priority and benefit from Swedish patent application No. 0400219-2, filed Feb. 3, 2004, the entire teachings of which are incorporated herein by reference.

### TECHNICAL FIELD

The present invention relates to a method and a device for forming patterns for bead-inlaid plates.

### BACKGROUND

Bead-inlaid plates are laid using artificial resin beads, also called tube beads, comprising short thick-walled cylindrical tube pieces of different colours. They can be laid to form various motifs. Computer programs for producing patterns for bead-inlaid plates are previously known, the programs including a drawing program part for producing a picture from which a pattern then is obtained. In the published European patent application 0 829 378 a method and a device for automatically producing a bead-inlaid plate from a given picture are disclosed. A picture is converted to an electronic format or already exists in an electronic format, the electronic representation is fed to an image processing unit that divides the picture in square areas and analyzes the colour of each area and determines a suitable colour for a bead to be placed on a position corresponding to the place of the analyzed area in the original picture, and thereupon the information determined by the image processing unit is input to an apparatus in which beads are placed on a base according to said information.

### SUMMARY OF THE INVENTION

It is an object of the invention to provide a method and a device for forming patterns for bead-inlaid plates that can use previously produced, original pictures.

In a method of forming patterns for bead-inlaid plates original pictures such as photographs are used which are converted to a digital, bitmapped representation. Thereupon, a pattern is produced from the digital representation by dividing the original picture using a grid of intersecting lines and then a colour matching for each square.

The method is performed by a user using a computer including associated software that is divided in various blocks or units. The computer including the software is an aid or assisting device for interactively creating patterns for bead-inlaid plates from pictures. Thus, the patterns are individually created and hence each pattern is unique. Thus, a personal interpretation of a photograph or another digital picture can be obtained. The individual patterns are created by adjusting colours, the light and contrast thereof. The number of different colours used in the grid dividing process can be determined by the user. The possibility of manual adjustment of individual beads after a grid dividing step gives the final personal interpretation.

The method offers the possibility for the user herself/himself or for her/him together with other persons to compose a bead-inlaid plate according to the new, created bead pattern which can also be seen as a new, created picture. Then, tube beads are placed having the calculated/chosen colours on a base, that can be a plate having upstanding pins and thereafter they can also be glued or melted to each other. Alternatively, they can obviously also be placed on a base having a frame and be adhesively bonded thereto.

The method cannot be compared to the previously known automatic apparatus for producing bead-inlaid plates mentioned above.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments presented hereinbelow with reference to the accompanying drawings, in which:

FIG. 1 is a schematic view of a computer monitor including a digitalized picture shown thereon,

FIG. 2 is a schematic view of a computer monitor including input fields for selection of format,

FIG. 3 is a schematic view of a computer monitor including a pattern for a bead inlaid plate and input fields for selection of colour quantities,

FIG. 4 is a schematic view similar to FIG. 3 including input fields for changing individual beads,

FIG. 5 is the digitalized picture according to FIG. 1 including a superposed grid of intersecting lines,

FIG. 6 is a picture including colour codes for beads obtained from FIG. 5,

FIG. 7 is a flow chart of a method of creating patterns for bead-inlaid plates, and

FIG. 8 is a block diagram of a device for creating patterns for bead-inlaid plates.

### DETAILED DESCRIPTION

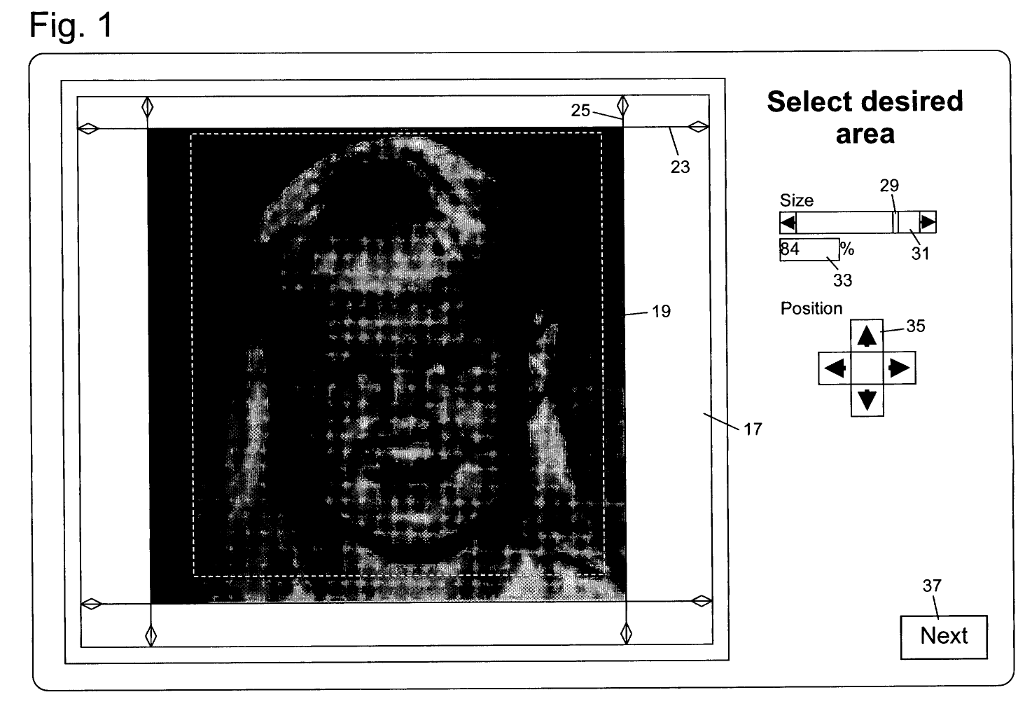

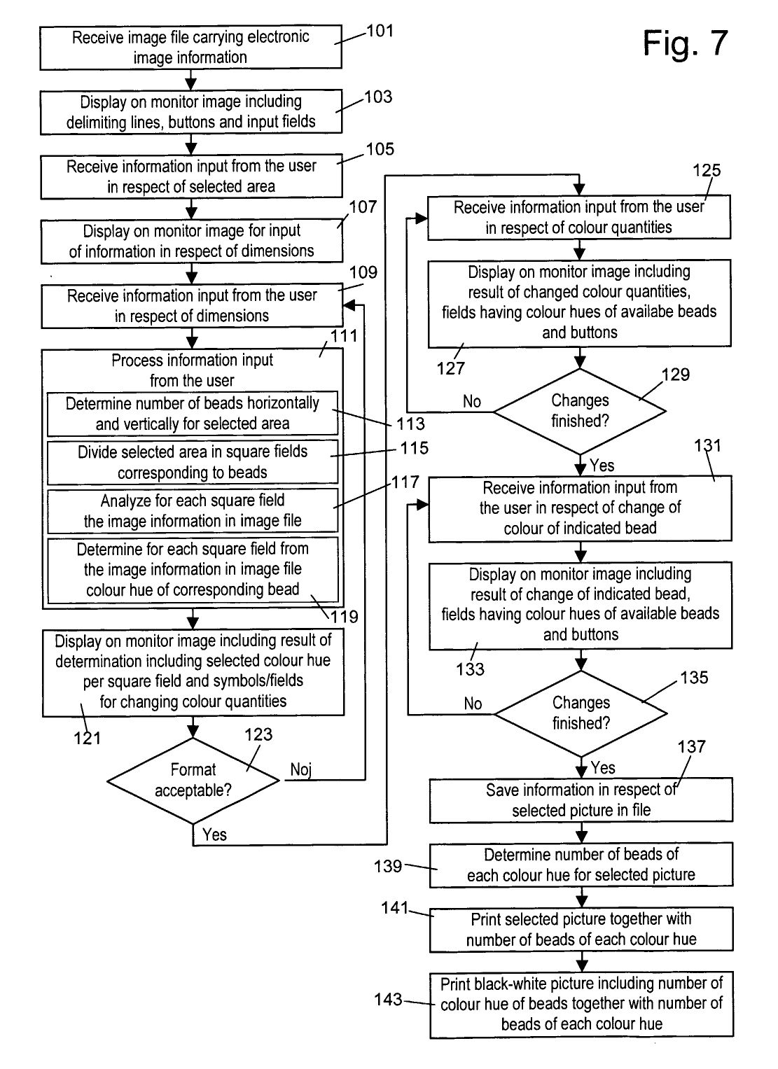

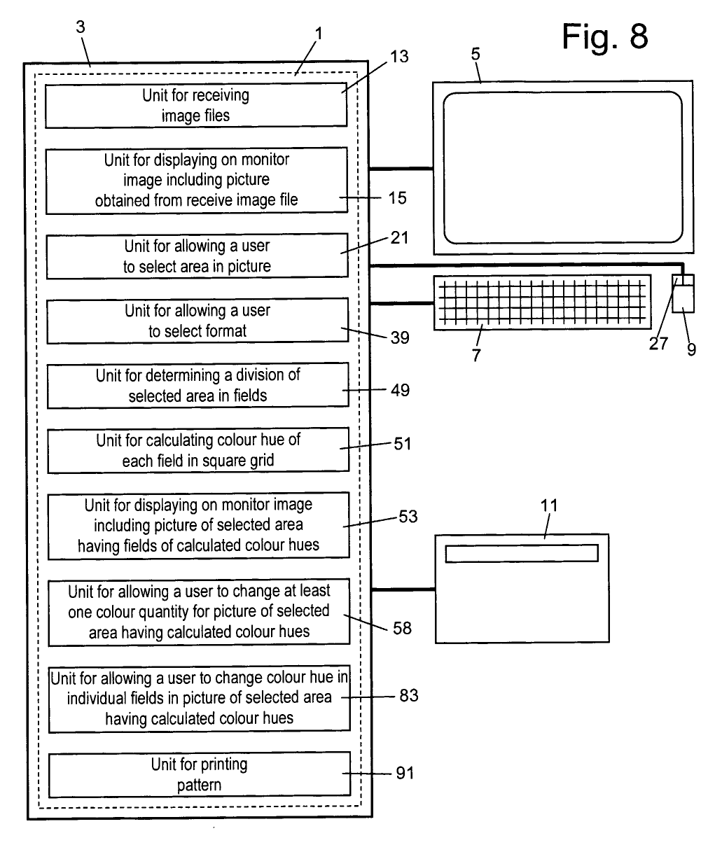

In creating a pattern for a bead-inlaid plate one starts from an original picture that is converted or has been converted to a digitalized bitmapped picture, e.g. a picture that is defined by an image file intended for processing in computers and to be shown on a monitor. The picture or image file can for example be obtained using an electronic image scanner. The picture file is processed by a specially designed program 1 in a computer 3, see FIG. 8, that also includes a monitor 5, input means such as a keyboard 7 and a computer mouse 9, and a printer 11. The receiving operation is executed by a unit 13 in the program, see also block 81 in the flow chart of FIG. 7. Then is first shown, by a program unit 15, a schematic image on the monitor of the computer, as is also seen in FIG. 1, see also block 103 in FIG. 7. In the displayed image, in a field 17, a picture 19 is shown that is obtained from the image file.

Thereupon, either the total picture can be selected or a part thereof using suitable input operations, by means of the program unit 21, see also block 105 in FIG. 7. On the shown picture two delimiting lines 23 can be provided extending horizontally and two delimiting lines 25 extending vertically, said lines being in their initial position placed at the edges of the picture. A user can, by operating the mouse 9 associated with the computer, displace selected ones of the delimiting lines to selected positions so that a selected area of the picture is delimited. Alternatively, an area can be delimited by first depressing a mouse button 27 with the cursor at the first corner of the desired area and thereupon pulling the cursor to the corresponding corner and there releasing the mouse button. A third possibility of selecting the size of the area is to set, using the computer mouse, a suitable size as a percentage of the total area by operating an indicator 29 in a field 31 or, using the keyboard 7, to write the size as a percentage of the size of the total area in an input field 33. The position of the area in the picture is selected by clicking on arrow symbols 35 using the computer mouse. By clicking on a suitable button 37 in the image displayed on the monitor, thereupon the delimited area is selected, see block 105 in FIG. 7.

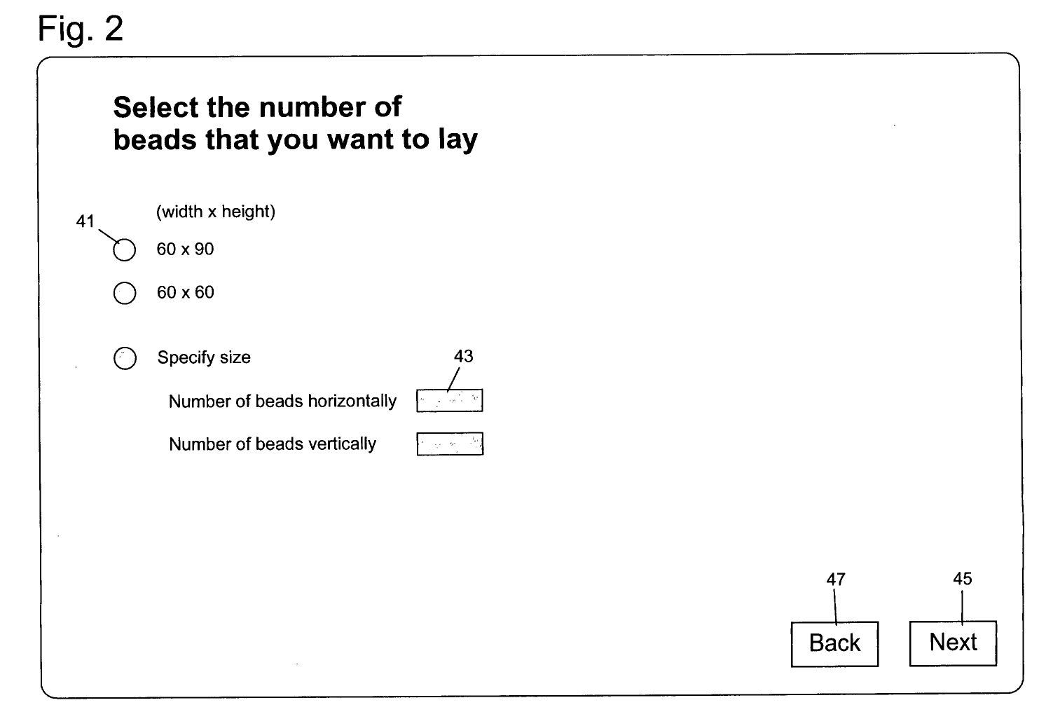

Then the format of the bead-inlaid plate is selected, i.e. the dimensions of the bead-inlaid plate. They can either be given as the dimension of the plate in lateral and height directions and preferably as the numbers of beads that the bead-inlaid plate is to obtain in the lateral and height directions. In order to perform this selection, a new image is displayed on the monitor, see FIG. 2, including suitable input fields and buttons, by means of a program unit 39, see also block 107 in FIG. 7. The input fields can for example include fields 41 for selecting predetermined numbers of beads in the side and height directions and fields 43 for input of numerical values. By clicking on a suitable button 45 in the image displayed on the monitor thereupon the delimited area is selected, see block 109 in FIG. 7. By clicking on another button 47 the user can if desired also return to the image previously displayed on the monitor to modify the selected area.

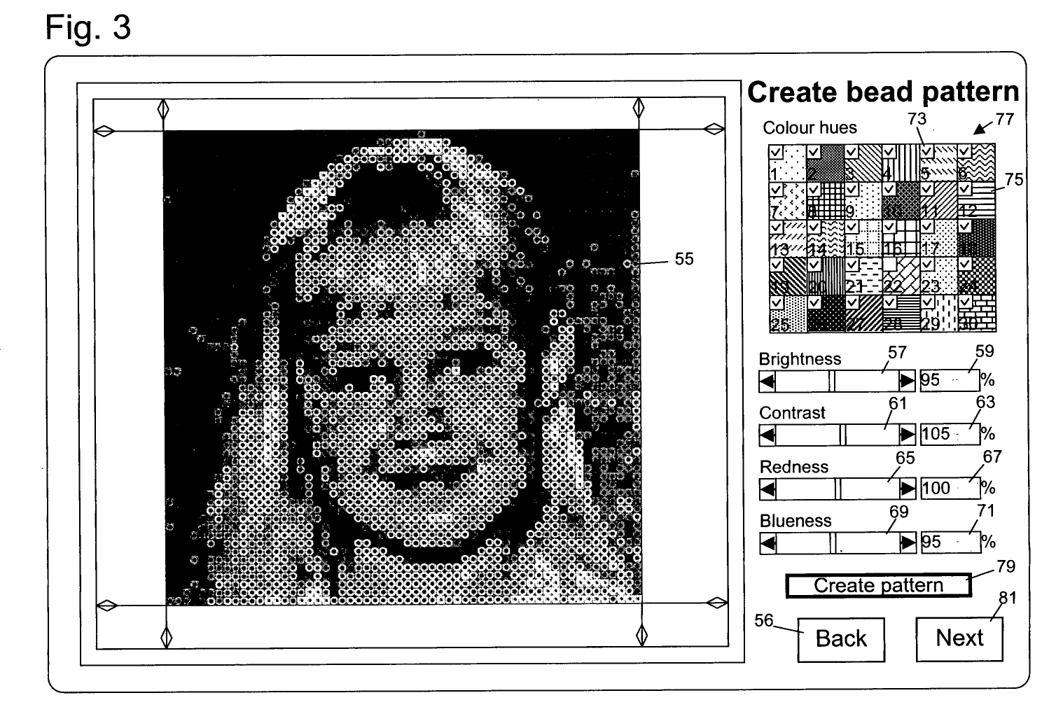

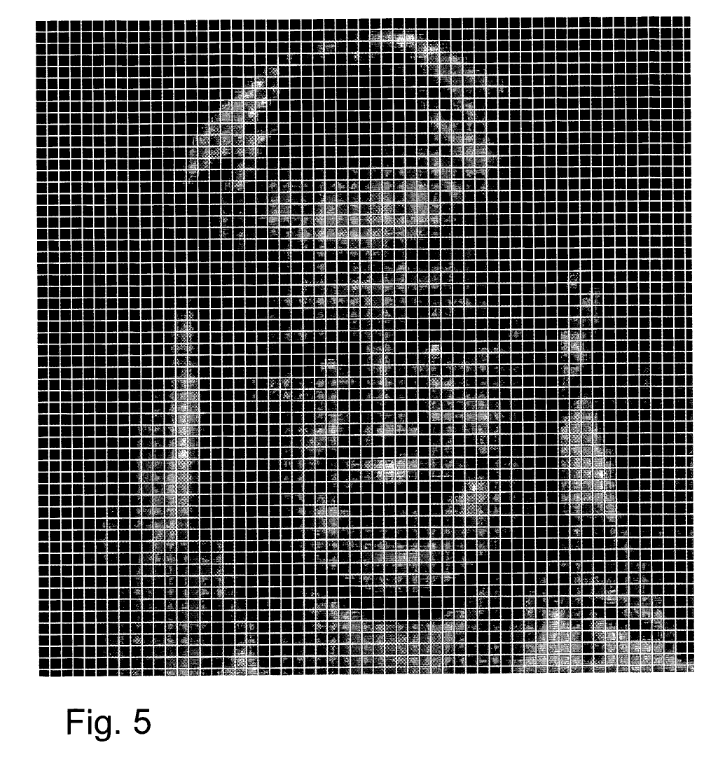

The image file is now processed by the program 1, see block 111 in FIG. 7. For the selected area, see block 113 in FIG. 7, the numbers of beads which are to be used horizontally and vertically are determined if they have not been indicated by the user in the preceding step. The picture is divided in a grid of intersecting lines so that squares having an equal size are formed, each of which corresponds to a bead, see FIG. 5, by a program unit 49, see also block 115 in FIG. 7. For each square the image information in the bitmap file, i.e. those pixels that correspond to the area of the square, is processed by a program unit 51, see block 117 in FIG. 7, and according to a suitable algorithm a colour hue is determined, selected among colour hues that are available for the artificial resin beads, for a best agreement between the colour hue in the square and the colour hue of the selected bead, see block 119 in FIG. 7. The beads can for example be provided in 30 different colour hues numbered Nos. 1-30. A resulting pattern including numbers for calculated colour hues is shown in FIG. 3. The program 1 shows, by means of a program unit 53, the result of the determination on the computer monitor by displaying a new image, see FIG. 3, in which, in the image 55 of the selected area for each square, only the calculated colour hue is shown or a picture of a bead having the colour hue calculated for this square is shown, see block 121 in FIG. 7.

In the selection of format the program can also by itself suggest a format and show a picture such as in FIG. 5 having a grid of intersecting lines. Thereupon the user can modify the format by changing the number of beads horizontally or vertically. After such a modification a new grid of intersecting lines can be shown which can be again modified, compare the block 123 in FIG. 7. Such a modification of format can also be made after the image on the monitor screen according to FIG. 3 has been displayed, by operating a suitable button such as 56 in FIG. 3. When the user is satisfied with the format she/he can click on a suitable confirming button that is displayed in the same time as the picture having the grid of intersecting lines.

Using the image displayed on the monitor and suitable input operations, the user can change, as is executed by a program unit 58, different colour quantities of the shown picture 55, such as its lightness, its colour saturation and colour mapping, by operating suitable symbols or changing suitable fields, that are simultaneously displayed on the monitor. Such symbols and fields can for example include colour scales, “colour scale mappings”, scales having a movable field, “indicator field”, that can be pulled in one of opposite directions by clicking and pulling, using the computer mouse, and input fields for suitable quantities. Such a scale and such an input field for brightness are shown at 57, 59, for contrast at 61, 63, for shading or tinting in red at 65, 67, for shading or tinting in blue at 69, 71. A particular colour hue or a plurality of colour hues can be excluded by the user clicking on a indicator field 73 existing in each colour hue field 75 in a colour palette 79 that is included in the image displayed on the monitor. The user's inputs in regard of the changes are confirmed by clicking on a suitable button, such as the button 79, “Create pattern”, see block 125 in FIG. 7. After such a change, see block 127 in FIG. 7, the resulting picture including the overlaid grid of intersecting lines or including images of individual beads, such as in FIG. 3, is shown. When the user is satisfied with the colour quantities, she/he can click on a suitable confirming button such as 81, compare block 129 in FIG. 7.

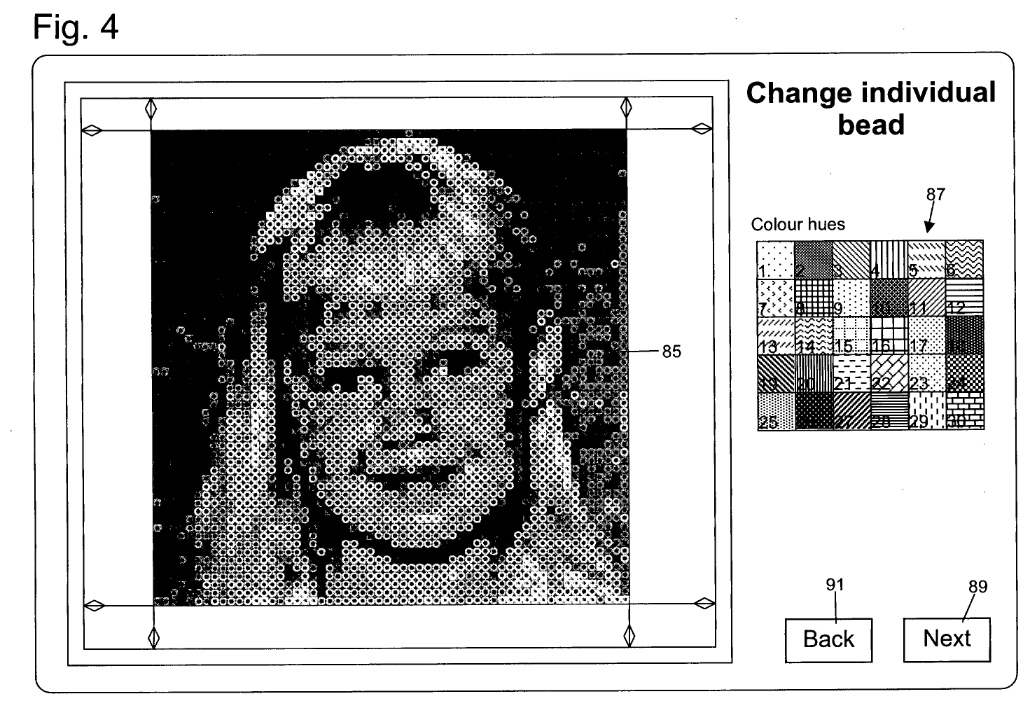

The user can thereafter, according to her/his desire, individually change the colour hue of each bead. Then, a new imaged on the monitor is displayed by a program unit 83, see FIG. 4. Then, the user can indicate a square or bead selected in the shown picture 85 and thereupon click on a colour hue in a colour palette 87 displayed on the monitor, in which palette the colour hues of all available beads are shown, see block 131 in FIG. 7. Thereupon, again the picture 85 is shown including the changed colour hue in the previously indicated square field, see block 133 in FIG. 7. The user can repeat the same procedure for each square and finally terminate the changes by clicking on a suitable button 89 in the image displayed on the monitor, compare block 135 in FIG. 7. The user can also return to the previous step of selecting colour quantities by clicking on another button 91.

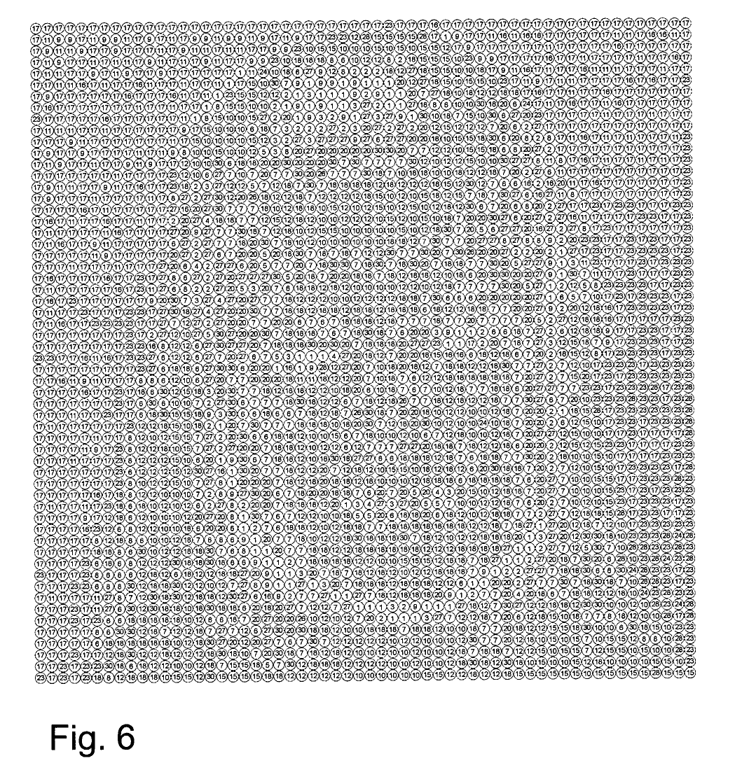

Finally, the selected pattern can be saved as a file that indicates the resulting pattern including numbers of selected colour hues of each square/bead, see block 137 in FIG. 7. The number of beads of each colour hue that is needed is calculated, see block 1379 in FIG. 7. Pictures can be printed by means of a program unit 91 that show the selected pattern for the laying operation including colour hues and including numbers of colour hues together with information about the number of beads of each colour hue that is required, see block 141 in FIG. 7. Alternatively, only a black and white picture including numbers of each colour hue for each square can be printed, compare FIG. 6, see block 143 in FIG. 7.

While specific embodiments of the invention have been illustrated and described herein, it is realized that numerous additional advantages, modifications and changes will readily occur to those skilled in the art. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention.

1. A method of creating a pattern for a bead-inlaid plate using a computer, comprising the steps of:
providing a colour picture,
converting the colour picture to a digital image file suited for electronic processing,
showing on a monitor associated with the computer the picture that corresponds to the digital image file,
selecting on the monitor, using a user input device of the computer, an area of the shown picture for which a pattern is to be created,
selecting a format of a bead-inlaid plate,
dividing the selected area of the shown picture into a grid of intersecting lines including squares of a uniform size, each of said squares corresponding to a bead on the bead-inlaid plate, so that the grid of intersecting lines also corresponds to the selected format,
determining according to a predetermined algorithm for each square that colour among colours available for beads which best represents or agrees with the colour of the square,
showing on the monitor a picture of the selected area including the colour determined for the square in each square,
changing on the monitor, using a user input device of the computer, at least one colour quantity for the picture of the selected area and/or changing the colour in individual squares, and
finally printing a pattern including the selected colours for the bead-inlaid plate.

2. A method according to claim 1, wherein the colour quantities include lightness, colour saturation and colour scale.

3. A method according to claim 1, wherein the steps of selecting format and dividing the selected area include the substeps that an initial format is first selected, that thereupon the selected area is divided according to the initial format, that on the monitor a picture including a grid of intersecting lines drawn according to the initial format is shown, that on the monitor, using a user input device of the computer, the initial format is changed to a changed format, that thereupon the selected area is divided according to the changed format, these substeps being repeated until a desired format has been obtained.

4. A device for forming a pattern for a bead-inlaid plate, comprising a computer including a receiving device for a digital image file suited for electronic processing, the computer including
a unit for showing on the monitor associated with the computer the picture that corresponds to the digital image file,
a unit for selecting on the monitor, using one of the user input devices of the computer, an area of the shown picture for which a pattern is to be formed,
a unit for selecting a format of a bead-inlaid plate,
a unit for dividing the selected area in the shown picture in a grid of intersecting lines including squares of a uniform size which each correspond to a bead on the bead-inlaid plate, so that the grid of intersecting lines also correspond to the selected format,
a unit for determining, according to a predetermined algorithm, for each square that colour hue among colour hues available for the beads which best represents or agrees with the colour hue in the square,
a unit for showing on the monitor a picture of the selected area including the colour determined for each square in each square,
a unit for selecting on the monitor, using a user input device of the computer, at least one colour quantity for the picture of the selected area and/or changing the colours in individual squares, and
a unit for finally printing a pattern including the selected colours for the bead-inlaid plate.
